(19) United States
(12) Patent Application Publication
(10) Pub. No.: US 2016/0038890 A1
(43) Pub. Date: Feb. 11, 2016

(54) APPARATUS AND METHOD FOR MIXING TUBE ASSEMBLY

(71) Applicant: Andrew Hobbs, Sheffield (GB)

(72) Inventor: Andrew Hobbs, Sheffield (GB)

(21) Appl. No.: 14/879,342

(22) Filed: Oct. 9, 2015

Related U.S. Application Data
(63) Continuation-in-part of application No. 13/422,228, filed on Mar. 16, 2012, now Pat. No. 9,188,330.
(60) Provisional application No. 61/465,215, filed on Mar. 16, 2011.

(51) Int. Cl. B01F 5/04; B01F 3/02

(52) U.S. Cl. CPC B01F 5/0403; B01F 3/02; B01F 2215/0085

(57) ABSTRACT

A mixing section adapted for use in a burner assembly comprising a plurality of mixing tube assemblies each comprising a substantially cylindrical outer wall which defines an interior open space and a plurality of holes which are disposed adjacent to the inlet end of each of the mixing tube assemblies. Preferably, air is conveyed from the inlet end to the outlet end of the mixing tube assemblies, fuel is conveyed to the interior open space defined by the substantially cylindrical outer wall through the plurality of holes, each of the mixing tube assemblies separately mixes an amount of fuel and air, and the mixing section is adapted to produce a mixture of fuel and air. A method comprising conveying fuel and air from the inlet end of the mixing tube assembly to the outlet end of the mixing tube assembly and mixing gaseous fuel and air in the assembly.

### CROSS-REFERENCES TO RELATED APPLICATIONS/PATENTS

This application is a continuation-in-part of, relates back to, and claims the benefit of priority from U.S. patent application Ser. No. 13/422,228 titled “Apparatus and Method for Mixing Tube Assembly” and filed on Mar. 16, 2012, which relates back to and claims the benefit of priority from U.S. Provisional Application for Patent No. 61/465,215 titled “Apparatus and Method for Mixing Tube With a Swirler” and filed on Mar. 16, 2011.

### FIELD OF THE INVENTION

The present invention relates generally to burner assemblies, and particularly to devices adapted to mix air and fuel in burner assemblies.

### BACKGROUND AND DESCRIPTION OF THE PRIOR ART

It is known to mix air and fuel in burner assemblies. Conventional devices used to mix air and fuel in burner assemblies, however, suffer from one or more disadvantages. For example, conventional devices used to mix air and fuel in burner assemblies are undesirably large and expensive to manufacture and operate. In addition, conventional devices used to mix air and fuel do not efficiently or sufficiently mix air and fuel together.

It would be desirable, therefore, if an apparatus and method for a device adapted to mix air and fuel in a burner assembly could be provided that would reduce the size and cost of manufacture and operation. In addition, it would also be desirable if such an apparatus and method could be provided that would mix air and fuel more efficiently, completely and uniformly.

### Advantages of the Preferred Embodiments of the Invention

Accordingly, it is an advantage of the preferred embodiments of the invention claimed herein to provide an apparatus and method for a device adapted to mix air and fuel in a burner assembly that reduces the size and cost of manufacture and operation. It is also an advantage of the preferred embodiments of the invention claimed herein to provide an apparatus and method that mixes air and fuel more efficiently, completely and uniformly.

Additional advantages of the preferred embodiments of the invention will become apparent from an examination of the drawings and the ensuing description.

### EXPLANATION OF TECHNICAL TERMS

As used herein, the term “turbulator” means swirlers, curved vanes, bluff bodies, tabs, lips, surface treatments and/or any other suitable device, mechanism, assembly or combination thereof which is adapted to mix fuel and air.

### SUMMARY OF THE INVENTION

The apparatus of the invention comprises a mixing section adapted for use in a burner assembly. The preferred mixing section comprises a plurality of mixing tube assemblies each having an inlet end and an outlet end and comprising a substantially cylindrical outer wall which defines an interior open space and a plurality of holes which are disposed adjacent to the inlet end of each of the plurality of mixing tube assemblies. Also in the preferred mixing section, air is conveyed from the inlet end to the outlet end of the mixing tube assemblies, fuel is conveyed to the interior open space defined by the substantially cylindrical outer wall through the plurality of holes, each of the plurality of mixing tube assemblies separately mixes an amount of fuel and air, and the mixing section is adapted to produce a mixture of fuel and air.

The method of the invention comprises a method for mixing fuel and air in a burner assembly. The preferred method comprises providing a mixing section adapted for use in a burner assembly. The preferred mixing section comprises a plurality of mixing tube assemblies each having an inlet end and an outlet end and comprising a substantially cylindrical outer wall which defines an interior open space and a plurality of holes which are disposed adjacent to the inlet end of each of the plurality of mixing tube assemblies. Also in the preferred mixing section, air is conveyed from the inlet end to the outlet end of the mixing tube assemblies, fuel is conveyed to the interior open space defined by the substantially cylindrical outer wall through the plurality of holes, each of the plurality of mixing tube assemblies separately mixes an amount of fuel and air, and the mixing section is adapted to produce a mixture of fuel and air. The preferred method also comprises conveying fuel and air from the inlet end of the mixing tube assembly to the outlet end of the mixing tube assembly and mixing gaseous fuel and air in the mixing tube assembly.

### BRIEF DESCRIPTION OF THE DRAWINGS

The presently preferred embodiments of the invention are illustrated in the accompanying drawings, in which like reference numerals represent like parts throughout, and in which:

FIG. 1 is a perspective view of the preferred mixing tube assembly in accordance with the present invention.

FIG. 2 is a partial sectional perspective view of an exemplary burner assembly including a plurality of the preferred mixing tube assemblies illustrated in FIG. 1.

FIG. 3 is a partial sectional perspective view of the exemplary burner assembly including a plurality of the preferred mixing tube assemblies illustrated in FIGS. 1 and 2.

FIG. 4 is an end view of the exemplary mixing section including a plurality of the preferred mixing tube assemblies illustrated in FIGS. 1 through 3.

FIG. 5 is a perspective view of the exemplary mixing section including a plurality of the preferred mixing tube assemblies illustrated in FIGS. 1 through 4.

FIG. 6 is a perspective view of the exemplary mixing section including a plurality of the preferred mixing tube assemblies illustrated in FIGS. 1 through 5.

FIG. 7 is a perspective view of a conventional mixing tube showing the concentration of gaseous fuel across a cross-sectional plane 28 inches downstream from the inlet end.

FIG. 8 is a perspective view of the preferred mixing tube assembly illustrated in FIGS. 1-6 showing the concentration of gaseous fuel across a cross-sectional plane 24 inches downstream from the inlet end.

FIG. 9 is a chart illustrating the concentration of gaseous fuel at different radial distances for a conventional mixing tube and the preferred mixing tube assembly illustrated in FIGS. 1-6 and 8.

FIG. 10 is a perspective view of a first alternative embodiment of the mixing tube assembly in accordance with the present invention.

FIG. 11 is a perspective view from the inlet end of an exemplary mixing section comprising a plurality of the first alternative embodiment of the mixing tube assembly illustrated in FIG. 10.

FIG. 12 is a perspective view from the outlet end of an exemplary mixing section comprising a plurality of the first alternative embodiment of the mixing tube assembly illustrated in FIG. 10.

### DESCRIPTION OF THE PREFERRED EMBODIMENTS OF THE INVENTION

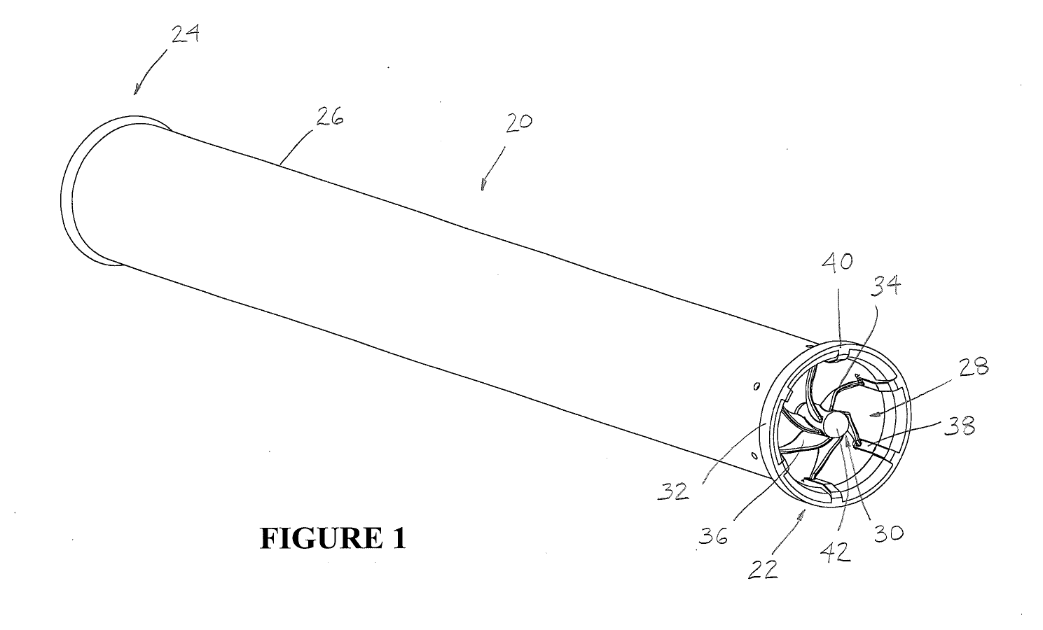

Referring now to the drawings, the preferred embodiment of the apparatus and method for a mixing tube assembly in accordance with the present invention is illustrated by FIGS. 1 through 6 and 8 through 12. As shown in FIGS. 1-12, the preferred embodiments of the apparatus and method for a mixing tube assembly are adapted to mix air and fuel in a burner assembly that reduces the size and cost of manufacture and operation. The preferred embodiments of the apparatus and method for a mixing tube assembly are also adapted to mix air and fuel more efficiently, completely and uniformly.

Referring now to FIG. 1, a perspective view of the preferred mixing tube assembly in accordance with the present invention is illustrated. As shown in FIG. 1, the preferred mixing tube assembly is designated generally by reference numeral 20. Preferred mixing tube assembly 20 has inlet end 22 and outlet end 24. Preferred mixing tube assembly 20 is adapted for use in a burner assembly such as a gaseous burner assembly, however, it is contemplated within the scope of the invention that the mixing tube assembly could be adapted for use in other suitable items of equipment or applications. Preferred mixing tube assembly 20 comprises substantially cylindrical outer wall 26 which defines interior open space 28. Preferred mixing tube assembly 20 further comprises turbulator 30. Preferred turbulator 30 is disposed in interior open space 28 defined by substantially cylindrical outer wall 26.

Still referring to FIG. 1, preferred substantially cylindrical outer wall 26 of mixing tube assembly 20 includes inlet end flare 32. Preferred inlet end flare 32 of substantially cylindrical outer wall 26 is disposed at inlet end 22 of mixing tube assembly 20. Preferred turbulator 30 is disposed in inlet end 22 of mixing tube assembly 20. Further, preferred turbulator 30 comprises swirler 34. Preferred swirler 34 is disposed in inlet end flare 32 of substantially cylindrical outer wall 26 and comprises plurality of curved vanes 36. Preferably, swirler 34 is attached to plurality of tabs 38. Preferred plurality of tabs 38 are disposed in inlet end 22 of mixing tube assembly 20 and attached to retainer ring 40 which is also disposed in the inlet end of the mixing tube assembly. Preferred turbulator 30 also comprises bluff body 42. Preferred bluff body 42 is spaced apart from substantially cylindrical outer wall 26 and disposed in inlet end 22 of mixing tube assembly 20. Preferred bluff body 42 is also attached to swirler 34, however, it is contemplated within the scope of the invention that the bluff body is not attached to the swirler.

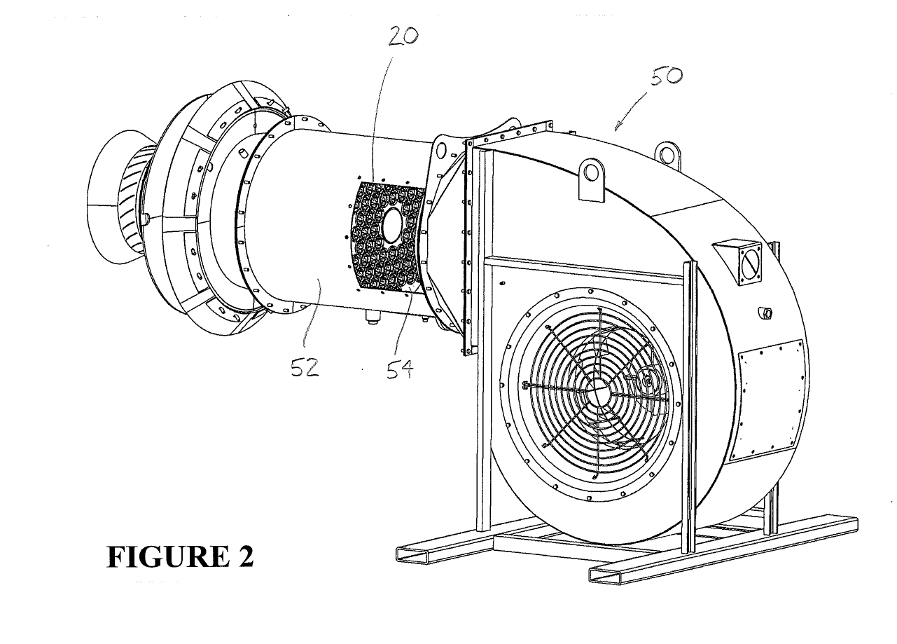

Referring now to FIG. 2, a partial sectional perspective view of exemplary burner assembly 50 including a plurality of preferred mixing tube assemblies 20 is illustrated. As shown in FIG. 2, the preferred plurality of mixing tube assemblies 20 are disposed in mixing section 52 of burner assembly 50. Preferred mixing section 52 further comprises inlet end tube sheet 54. While preferred mixing section 52 comprises a plurality of mixing tube assemblies 20, it is contemplated within the scope of the invention that mixing section 52 comprises only one mixing tube assembly.

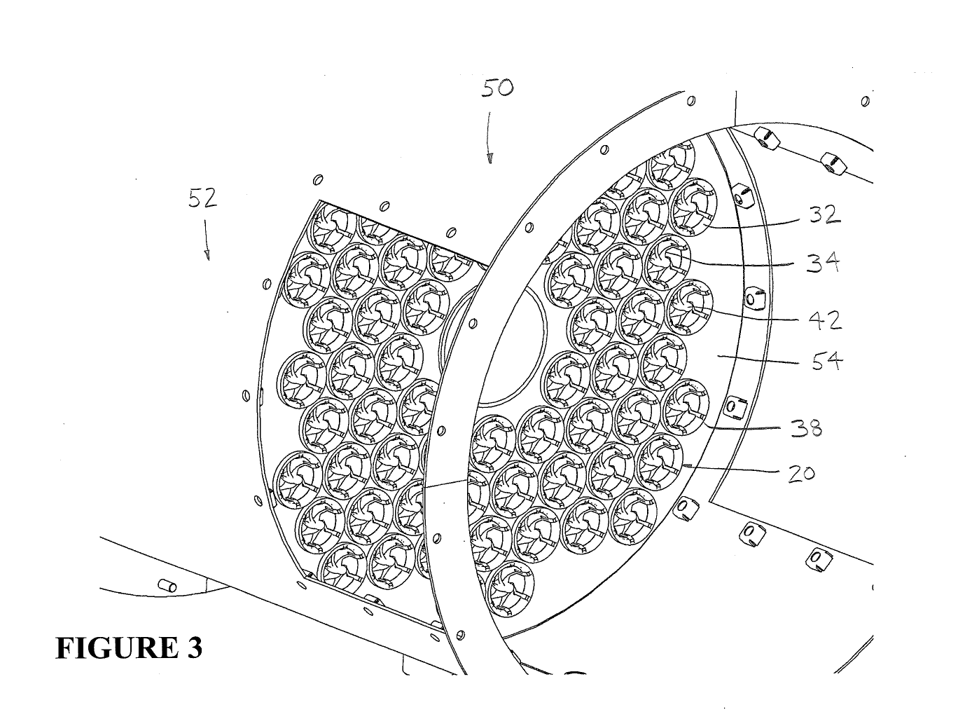

Referring now to FIG. 3, a partial sectional perspective view of exemplary burner assembly 50 including a plurality of preferred mixing tube assemblies 20 is illustrated. As shown in FIG. 3, preferred mixing section 52 comprises inlet end flare 32, swirler 34, tabs 38, bluff body 42 and inlet end tube sheet 54.

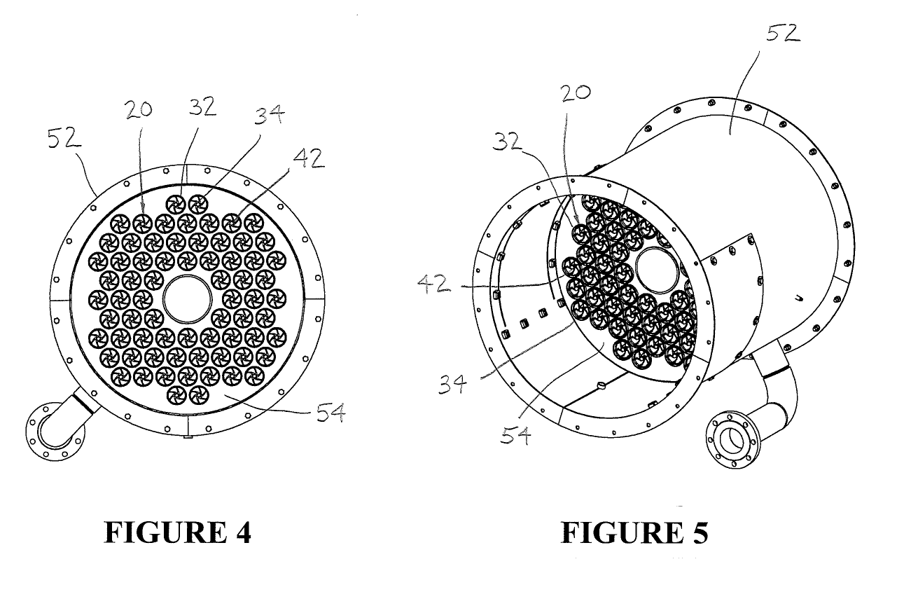

Referring now to FIG. 4, an end view of exemplary mixing section 52 including a plurality of the preferred mixing tube assemblies 20 is illustrated. As shown in FIG. 4, preferred mixing section 52 includes inlet end flare 32, swirler 34, bluff body 42 and inlet end tube sheet 54.

Referring now to FIG. 5, a perspective view of exemplary mixing section 52 including a plurality of the preferred mixing tube assemblies 20 is illustrated. As shown in FIG. 5, preferred mixing section 52 includes inlet end flare 32, swirler 34, bluff body 42 and inlet end tube sheet 54.

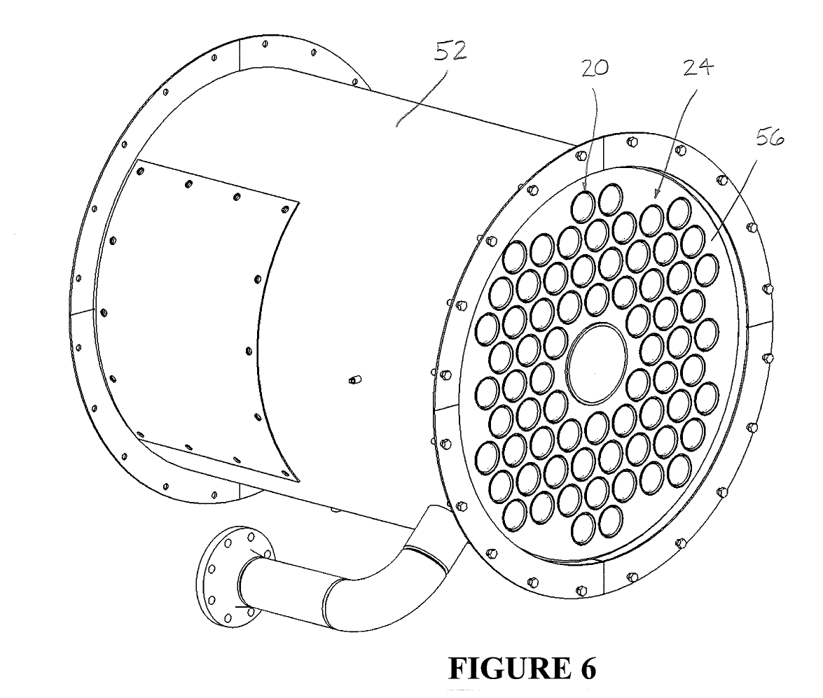

Referring now to FIG. 6, a perspective view of exemplary mixing section 52 including a plurality of the preferred mixing tube assemblies 20 is illustrated. As shown in FIG. 6, preferred mixing section 52 includes outlet end 24 of mixing tube assemblies 20 and outlet end tube sheet 56.

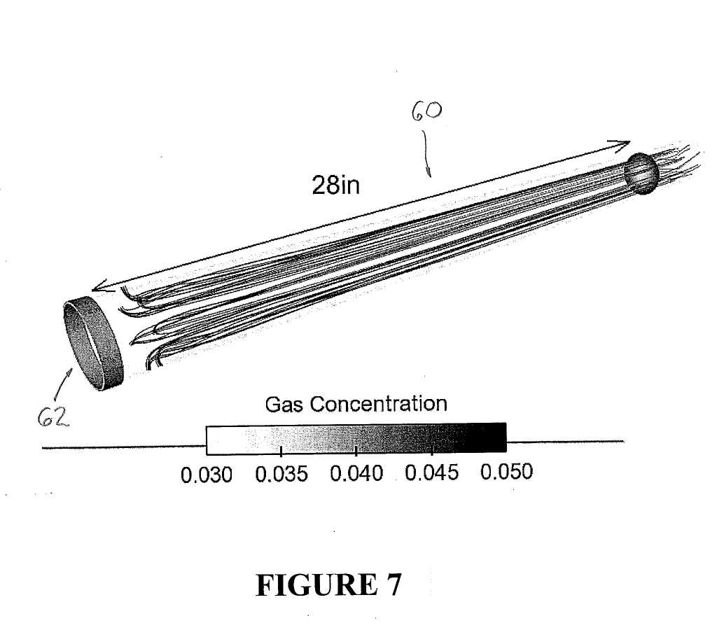

Referring now to FIG. 7, a perspective view of a conventional mixing tube showing the concentration of gaseous fuel across a cross-sectional plane 28 inches downstream from inlet end 62 is illustrated. As shown in FIG. 7, the conventional mixing tube is designated generally by reference numeral 60. Conventional mixing tube 60 causes the concentration of gaseous fuel within the tube to increase near the outer wall and to decrease near the center of the tube.

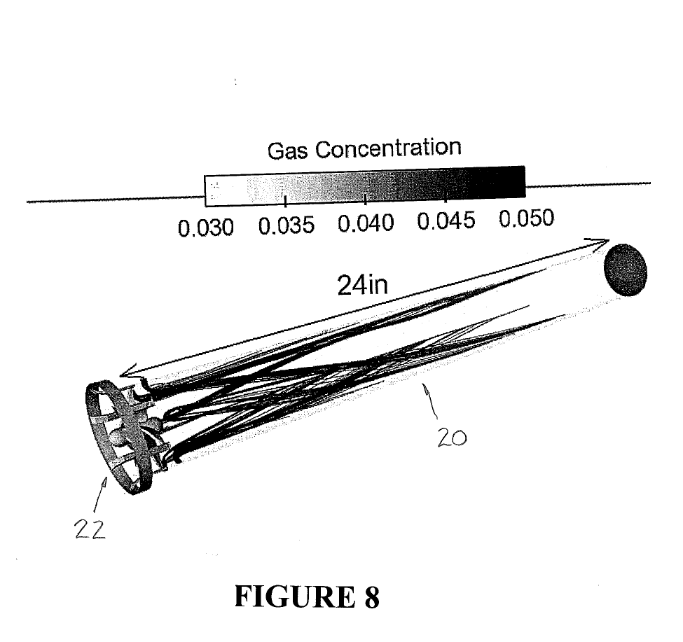

Referring now to FIG. 8, a perspective view of preferred mixing tube assembly 20 showing the concentration of gaseous fuel across a cross-sectional plane 24 inches downstream from inlet end 22 is illustrated. As shown in FIG. 8, preferred mixing tube assembly 20 causes the concentration of gaseous fuel within the tube to more uniform and in a shorter distance than conventional mixing tube 60.

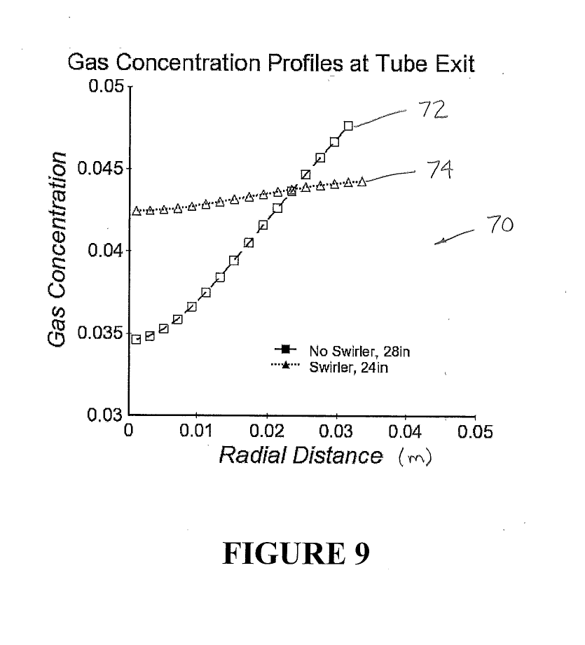

Referring now to FIG. 9, a chart illustrating the concentration of gaseous fuel at different radial distances for conventional mixing tube 60 and the preferred mixing tube assembly 20 is illustrated. As shown in FIG. 9, the chart is generally designated by reference numeral 70. As shown in chart 70, points 72 represent the gas concentration at different radial distances in conventional mixing tube 60 and points 74 represent the gas concentration at different radial distances in preferred mixing tube 20. More particularly, chart 70 illustrates the mass fraction of methane at radial units (meters) at 28 inches downstream from inlet end 62 of conventional mixing tube 60 and at 24 inches downstream from inlet end 22 of preferred mixing tube assembly 20.

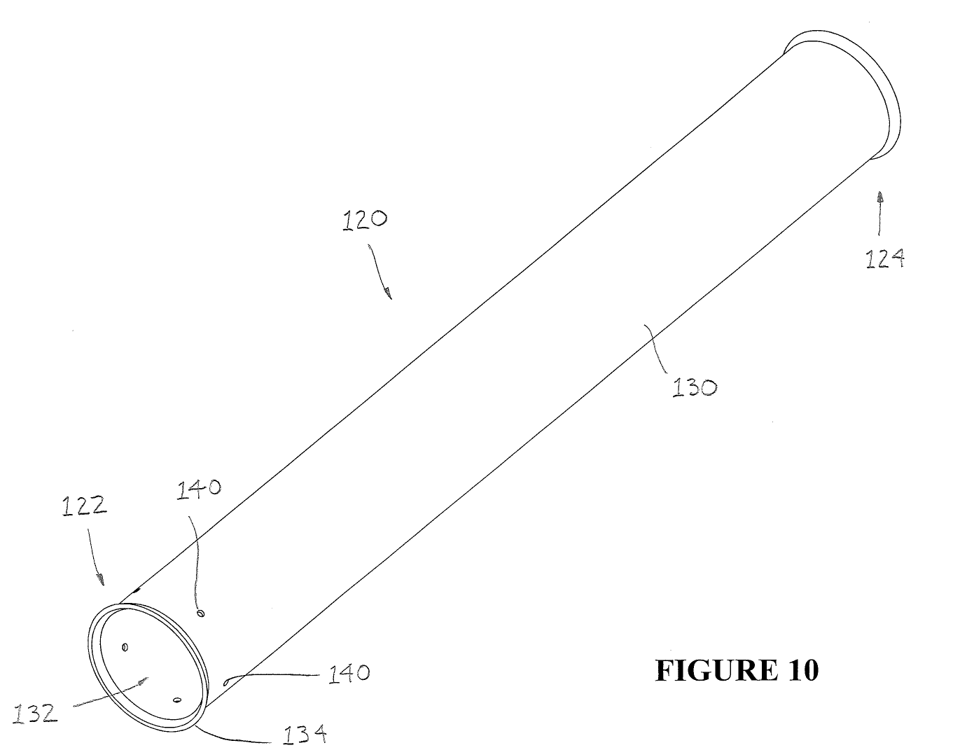

Referring now to FIG. 10, a perspective view of a first alternative embodiment of the mixing tube assembly in accordance with the present invention is illustrated. As shown in FIG. 10, the preferred mixing tube assembly is designated generally by reference numeral 120. Preferred mixing tube assembly 120 has inlet end 122 and outlet end 124. Preferred mixing tube assembly 120 also comprises substantially cylindrical outer wall 130 which defines interior open space 132. Preferably, substantially cylindrical outer wall 130 has inlet end flare 134 which is disposed at inlet end 122 of mixing tube assembly 120. Each of the preferred mixing tube assemblies 120 has a radius of less than approximately 1.40 inches. More preferably, each of the mixing tube assemblies 120 has a radius of approximately 1.14 inches. Each of the preferred mixing tube assemblies 120 also has a length of more than approximately 18 inches. More preferably, each of the mixing tube assemblies 120 has a length of approximately 30 inches. While FIG. 10 illustrates the preferred configuration and arrangement of the substantially cylindrical outer wall, it is contemplated within the scope of the invention that the outer wall may be of any suitable configuration and arrangement.

Still referring to FIG. 10, preferred mixing tube assembly 120 also comprises a plurality of holes 140 which are disposed adjacent to inlet end 122 of each of the plurality of mixing tube assemblies 120. Preferably, plurality of holes 140 comprises five circular holes each having a diameter in the range of approximately 0.152 inches to approximately 0.166 inches. More preferably, each of the plurality of holes 140 has a diameter of approximately 0.152 inches. Preferred plurality of holes 140 is disposed in a circular configuration around each mixing tube assembly 120 at inlet end 122 of each mixing tube assembly 120. Preferably, each of the plurality of holes 140 is spaced equally apart from each other, and the holes are uniformly disposed around each mixing tube assembly 120. While FIG. 10 illustrates the preferred configuration and arrangement of the plurality of holes, it is contemplated within the scope of the invention that the plurality of holes may be of any suitable configuration and arrangement. It is also contemplated within the scope of the invention that the plurality of holes may comprise fewer or more than five holes.

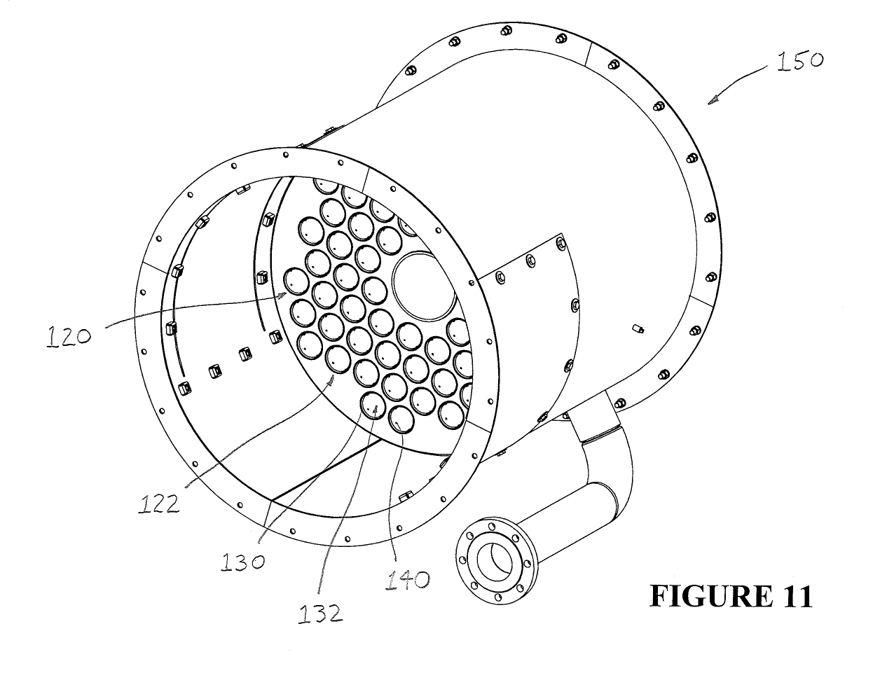

Referring now to FIG. 11, a perspective view from the inlet end of an exemplary mixing section comprising a plurality of preferred mixing tube assemblies 120 is illustrated. As shown in FIG. 11, the exemplary mixing section is designated generally by reference numeral 150. Preferred mixing section 150 is adapted for use in a burner assembly such as exemplary burner assembly 50 illustrated in FIGS. 2 and 3. Preferably, exemplary burner assembly 50 is adapted to fire in the range of approximately 50 MMBTU/hour to approximately 150 MMBTU/hour and the fuel has a fuel velocity in the range of approximately 530 feet/second to approximately 650 feet/second. More preferably, the fuel has a fuel velocity in the range of approximately 600 feet/second to approximately 630 feet/second. It is contemplated within the scope of the invention, however, that the exemplary burner assembly may fire at less than 50 MMBTU/hour and more than 150 MMBTU/hour. It is also contemplated within the scope of the invention that the fuel velocity may be less than 530 feet/second and more than 650 feet/second.

Still referring to FIG. 11, exemplary mixing section 150 comprises a plurality of mixing tube assemblies 120. Preferably, air is conveyed from inlet end 122 to the outlet end of the plurality of mixing tube assemblies 120, and fuel is conveyed to interior open space 132 of substantially cylindrical outer wall 130 through the plurality of holes 140. Also in the preferred embodiments of mixing section 150, each of the plurality of mixing tube assemblies 120 separately mixes an amount of fuel and air, and the mixing section is adapted to produce a mixture of fuel and air. While FIG. 11 illustrates the preferred configuration and arrangement of the exemplary mixing section, it is contemplated within the scope of the invention that the mixing section may be of any suitable configuration and arrangement. It is also contemplated within the scope of the invention that the mixing section comprises fewer or more mixing tube assemblies than illustrated in FIG. 11.

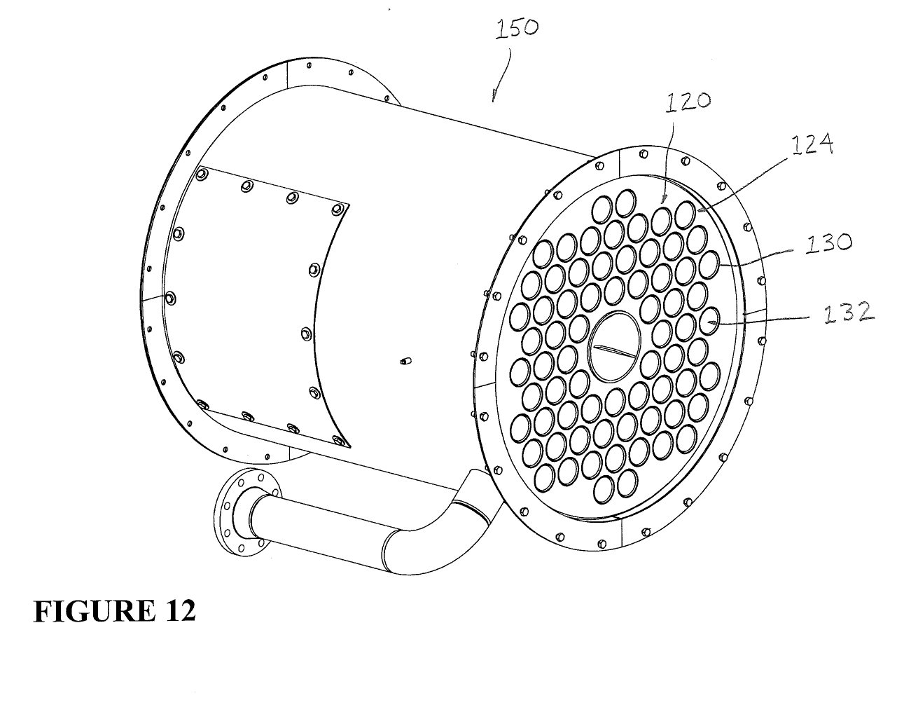

Referring now to FIG. 12, a perspective view from the outlet end of exemplary mixing section 150 is illustrated. As shown in FIG. 12, exemplary mixing section 150 comprises plurality of mixing tube assemblies 120 each having outlet end 124, substantially cylindrical outer wall 130, and interior open space 132.

The invention also comprises a method for mixing fuel and air in a burner assembly. The preferred method comprises providing a mixing tube assembly having an inlet end and an outlet end. The preferred mixing tube assembly comprises a substantially cylindrical outer wall which defines an interior open space. The preferred mixing tube assembly also comprises a turbulator that is disposed in the interior open space defined by the substantially cylindrical outer wall. The preferred method also comprises conveying fuel and air from the inlet end of the mixing tube assembly to the outlet end of the mixing tube assembly.

In another preferred embodiment, the method comprises a turbulator having a retainer ring that is disposed at the inlet end of the mixing tube assembly, a plurality of tabs that are attached to the retainer ring, a swirler that is attached to the plurality of tabs and a bluff body that is attached to the swirler. In still another preferred embodiment, the method comprises mixing gaseous fuel and air in the mixing tube assembly.

In still another preferred embodiment, the method comprises providing a mixing section adapted for use in a burner assembly. The preferred mixing section comprises a plurality of mixing tube assemblies each having an inlet end and an outlet end and comprising a substantially cylindrical outer wall which defines an interior open space and a plurality of holes which are disposed adjacent to the inlet end of each of the plurality of mixing tube assemblies. Also in the preferred mixing section, air is conveyed from the inlet end to the outlet end of the mixing tube assemblies, fuel is conveyed to the interior open space defined by the substantially cylindrical outer wall through the plurality of holes, each of the plurality of mixing tube assemblies separately mixes an amount of fuel and air, and the mixing section is adapted to produce a mixture of fuel and air. The preferred method also comprises conveying fuel and air from the inlet end of the mixing tube assembly to the outlet end of the mixing tube assembly and mixing gaseous fuel and air in the mixing tube assembly.

In operation, several advantages of the preferred embodiments of the invention are achieved. For example, the preferred embodiments of the apparatus and method for a mixing tube assembly are adapted to mix air and fuel in a burner assembly that reduces the size and cost of manufacture and operation. The preferred embodiments of the apparatus and method for a mixing tube assembly are also adapted to mix air and fuel more efficiently, completely and uniformly.

Although this description contains many specifics, these should not be construed as limiting the scope of the invention but as merely providing illustrations of some of the presently preferred embodiments thereof, as well as the best mode contemplated by the inventors of carrying out the invention. The invention, as described herein, is susceptible to various modifications and adaptations, and the same are intended to be comprehended within the meaning and range of equivalents of the appended claims.

What is claimed is:

1. A mixing section adapted for use in a burner assembly, said mixing section comprising a plurality of mixing tube assemblies, each of said mixing tube assemblies having an inlet end and an outlet end and comprising:
(a) a substantially cylindrical outer wall, said substantially cylindrical outer wall defining an interior open space;
(b) a plurality of holes, said plurality of holes being disposed adjacent to the inlet end of each of the plurality of mixing tube assemblies;
wherein air is conveyed from the inlet end to the outlet end of the mixing tube assemblies; and wherein fuel is conveyed to the interior open space defined by the substantially cylindrical outer wall through the plurality of holes; and wherein each of the plurality of mixing tube assemblies separately mixes an amount of fuel and air; and wherein the mixing section is adapted to produce a mixture of fuel and air.

2. The mixing section of claim 1 wherein the substantially cylindrical outer wall has an inlet end flare.

3. The mixing section of claim 2 wherein the inlet end flare of the substantially cylindrical outer wall is disposed at the inlet end of the mixing tube assembly.

4. The mixing section of claim 1 wherein the plurality of holes comprises five circular holes.

5. The mixing section of claim 1 wherein the each of the plurality of holes has a diameter in the range of approximately 0.152 inches to approximately 0.166 inches.

6. The mixing section of claim 1 wherein each of the plurality of holes has a diameter of approximately 0.152 inches.

7. The mixing section of claim 1 wherein the plurality of holes is disposed in a circular configuration around each mixing tube assembly.

8. The mixing section of claim 1 wherein the plurality of holes is disposed at the inlet end of each mixing tube assembly.

9. The mixing section of claim 1 wherein each of the plurality of holes is spaced equally apart from each other.

10. The mixing section of claim 1 wherein the plurality of holes is uniformly disposed around each mixing tube assembly.

11. The mixing section of claim 1 wherein each of the mixing tube assemblies has a radius of less than approximately 1.40 inches.

12. The mixing section of claim 1 wherein each of the mixing tube assemblies has a radius of approximately 1.14 inches.

13. The mixing section of claim 1 wherein each of the mixing tube assemblies has a length of more than approximately 18 inches.

14. The mixing section of claim 1 wherein each of the mixing tube assemblies has a length of approximately 30 inches.

15. The mixing section of claim 1 wherein the fuel has a fuel velocity in the range of approximately 530 feet/second to approximately 650 feet/second.

16. The mixing section of claim 1 wherein the fuel has a fuel velocity in the range of approximately 600 feet/second to approximately 630 feet/second.

17. The mixing section of claim 1 wherein the burner assembly is adapted to fire in the range of approximately 50 MMBTU/hour to approximately 150 MMBTU/hour.

18. A mixing section adapted for use in a burner assembly that is adapted to fire in the range of approximately 50 MMBTU/hour to approximately 150 MMBTU/hour, said mixing section comprising a plurality of mixing tube assemblies, each of said mixing tube assemblies having an inlet end and an outlet end and comprising:
(a) a substantially cylindrical outer wall, said substantially cylindrical outer wall defining an interior open space and having an inlet end flare;
(b) five holes, said five holes being uniformly disposed around the inlet end of each of the plurality of mixing tube assemblies;
wherein air is conveyed from the inlet end to the outlet end of the mixing tube assemblies; and wherein fuel is conveyed to the interior open space defined by the substantially cylindrical outer wall through the five holes; and wherein each of the plurality of mixing tube assemblies separately mixes an amount of fuel and air; and wherein the mixing section is adapted to produce a mixture of fuel and air.

19. A method for mixing fuel and air in a burner assembly, said method comprising:
(a) providing a mixing section adapted for use in a burner assembly, said mixing section comprising a plurality of mixing tube assemblies, each of said mixing tube assemblies having an inlet end and an outlet end and comprising:
(1) a substantially cylindrical outer wall, said substantially cylindrical outer wall defining an interior open space;
(2) a plurality of holes, said plurality of holes being disposed adjacent to the inlet end of each of the plurality of mixing tube assemblies;
wherein air is conveyed from the inlet end to the outlet end of the mixing tube assemblies; and wherein fuel is conveyed to the interior open space defined by the substantially cylindrical outer wall through the plurality of holes; and wherein each of the plurality of mixing tube assemblies separately mixes an amount of fuel and air; and wherein the mixing section is adapted to produce a mixture of fuel and air;
(b) conveying fuel and air from the inlet end of the mixing tube assembly to the outlet end of the mixing tube assembly.

20. The method of claim 19 further comprising:
(c) mixing gaseous fuel and air in the mixing tube assembly.
